(19) United States
(12) Patent Application Publication
(10) Pub. No.: US 2025/0005466 A1
(43) Pub. Date: Jan. 2, 2025

(54) SYSTEMS AND METHODS FOR EVENT ORGANIZING AND ATTENDING ECOSYSTEM

(71) Applicant: Nrby.io, Inc., Wayzata, MN (US)

(72) Inventors: Robert Jason Vlaich Flessner, Wayzata, MN (US); Adam Ramzey Hammad, Minneapolis, MN (US); Anthony Albert LaMartina, Burnsville, MN (US); Kelly Thomas Pangburn, Lakeville, MN (US)

(21) Appl. No.: 18/690,206

(22) PCT Filed: Sep. 7, 2022
(86) PCT No.: PCT/US22/42815

§ 371 Date: Mar. 7, 2024

Related U.S. Application Data
(60) Provisional application No. 63/241,528, filed on Sep. 7, 2021.

(51) Int. Cl. G06Q 10/0631

(52) U.S. Cl. CPC G06Q 10/0631

(57) ABSTRACT

The present disclosure relates to a novel and advantageous system and method for event organizing and attending. In particular, the present disclosure relates to an event system including a user module, an organizer module, and an administrator module. The event system is usable by an event organizer to plan an event, book a venue, offer merchandise, and offer ticketing. The event system is usable by a user to receive recommendations about events, to buy tickets to events, and to organize a group of people to attend events and communicate about and at the event.

### CROSS-REFERENCE TO RELATED APPLICATIONS

The present application claims priority to the U.S. Provisional Application No. 63/241,528, entitled SYSTEMS AND METHODS FOR EVENT ORGANIZING AND ATTENDING ECOSYSTEM, and filed 7 Sep. 2021, the content which is hereby incorporated by reference in its entirety

### FIELD OF THE INVENTION

The present disclosure relates to a novel and advantageous system and method for event organizing and attending. In particular, the present disclosure relates to an event system including a user module, an organizer module, and an administrator module. The event system is usable by an event organizer to plan an event, book a venue, offer merchandise, and offer ticketing. The event system is usable by a user to receive recommendations about events, to buy tickets to events, and to organize a group of people to attend events and communicate about and at the event.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Many events occur on any given night in any given city. No easy means exist for finding all events that may be interesting to a user. Further, no comprehensive system exists for finding events, receiving recommendations to events, inviting others to events, buying tickets to the events, and rating events.

As an event organizer, it can be difficult to anticipate likely success of an event. Factors that go into success include how many other similar events are in a given region. Currently, no means exist for an event organizer to evaluate likelihood of success of an event and get recommendations for increasing the likelihood of success for an event.

A need exists for a system for event planning for attendees and organizers.

### BRIEF SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

In one embodiment, a system for event organizing and attending is provided. The system may comprise a user API server and a user interface associated with the user API server, an admin server, an event organizer API server and an event organizer interface associated with the event organizer API server, and a cloud server linked to each of the user API server, the admin server, and the event organizer API. A least one task algorithm may be associated with the cloud server, wherein the at least one task algorithm includes an event recommender task algorithm, wherein the event recommender task algorithm uses data from a user and data about an event to make an event recommendation to a user based on a percent match. The event recommender task algorithm may use event data from an event organizer and regional data to make event hosting recommendations based on a likelihood of success. The at least one task algorithm may further comprise an event archiver schedule task algorithm and a web scraper schedule task algorithm.

In another embodiment, a method for making recommendations to user, wherein the user is an event goer, is provided. The method may comprise receiving user preferences regarding events, developing a user profile based on the received user preferences, comparing the user preferences against event data for an event, calculating a percent match between the user profile and the event, and presenting the percent match to the event goer. The method may further comprise refining the user profile based on events attended by the user.

The method may further comprise calculating percent matches between friend user profiles and the event and presenting the percent matches to the user, wherein the user may invite friends to the event based on the percent match of the friend user profile and the event. In some embodiments, friends who accept an invitation form the user are grouped into an event group. The user may set a meet time for the event. The method may further comprise sending a notification to members of the event group. The notification may be sent when a member purchases a ticket to the event and/or when a member arrives at the event.

In some embodiments, the method may further comprise identifying upcoming events, comparing the user preferences against event data for the upcoming events, and sending notifications to the user with recommendations for certain upcoming events. The certain upcoming events may be selected based on calculating a percent match between the user profile and each event and choosing the certain events based on events that exceed a threshold percent match.

In a further embodiment, a method for making recommendations to a user, wherein the user is an event organizer, is provided. The method may comprise receiving proposed event details for a proposed event, comparing the proposed event details against existing event details of scheduled events, calculating a percent likelihood of success of the proposed event, and presenting the percent likelihood of success to the event organizer. The proposed event details may include the type of event, date, time, and/or region. The method may further comprise evaluating alternative event details for the proposed event, calculating a percent likelihood of success based on the alternative event details, and presenting at least one alternative recommendation for the event. The at least one alternative recommendation may be made based on exceeding a threshold percent likelihood of success. The method may further comprise providing analytics regarding the event after the event takes place.

In yet another embodiment, computer-readable storage medium containing program instructions for a method for making recommendations to an event goer and making recommendations to an event organizer, wherein execution of the program instructions by one or more processors of a computer system causes the one or more processors to perform steps, may be provided. The steps may comprise, for making recommendations to an event goer, receiving user preferences regarding events, comparing the user preferences against event data for an event, calculating a percent match between the user preferences and the event data, and presenting the percent match to the event goer. The steps may further comprise, for making recommendations to an event organizer, receiving proposed event details for a proposed event, the proposed event details including date, time, and region, comparing the proposed event details against existing event details of scheduled events, calculating a percent likelihood of success of the proposed event, and presenting the percent likelihood of success to the event organizer.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1a illustrates a flow chart of how a user uses the event system, in accordance with one embodiment.

FIG. 1b illustrates a flow chart of how users can use the event system in conjunction with a third party app, in accordance with one embodiment.

FIG. 2a illustrates a flow chart of group creation and use in the event system, in accordance with one embodiment.

FIG. 2b illustrates a flow chart of group creation and use for a specific event, in accordance with one embodiment.

FIG. 3a illustrates a flow chart of how an event organizer uses the event system, in accordance with one embodiment.

FIG. 3b illustrate a flow chart of how an event organizer uses the event system, in accordance with one embodiment.

FIG. 4 illustrates a block diagram of an exemplary event system, in accordance with one embodiment.

FIG. 5 illustrates a confidence circle of a user display, in accordance with one embodiment.

FIG. 6a illustrates a search screen overlaying a map of an area, in accordance with one embodiment.

FIG. 6b illustrates a result screen of a search for a keyword, in accordance with one embodiment.

FIG. 7 illustrates pins that may be provided on a map, in accordance with one embodiment.

FIG. 8 illustrates a map with pins, in accordance with one embodiment.

FIG. 9 illustrates an event card, in accordance with one embodiment.

FIG. 10 illustrates a friend selection screen, in accordance with one embodiment.

FIG. 11 illustrates an invitation screen, in accordance with one embodiment.

FIG. 12 illustrates a group event details screen, in accordance with one embodiment.

FIG. 13 illustrates an upcoming events screen, in accordance with one embodiment.

FIG. 14 illustrates a flow chart of the event system being used as a total ticket centralization system.

### DETAILED DESCRIPTION

The present disclosure relates to a novel and advantageous system and method for event organizing and attending. In particular, the present disclosure relates to an event system including a user module, an organizer module, and an administrator module. An event database is linked to each of the user module, the organizer module, and the administrator module. A plurality of algorithms are provided for use within one or more of the modules. The event system is usable by an event organizer to plan an event, book a venue, and offer ticketing. The event system is usable by a user to receive recommendations about events, to buy tickets to events, and to organize a group of people to attend events and communicate about and at the event. In some embodiments, the event system may work with another system, such as a dating system, for facilitating connection between two users based on interests in similar types of events. In general, recommendations may be made based on events exceeding a threshold percentage match to a event attendee or based on event exceeding a threshold percent likelihood of success for an event organizer. The threshold percentage match or the threshold percent likelihood of success may be set by the user.

### User Experience

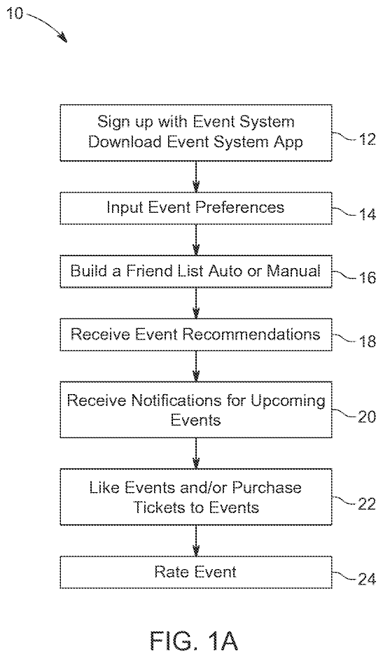

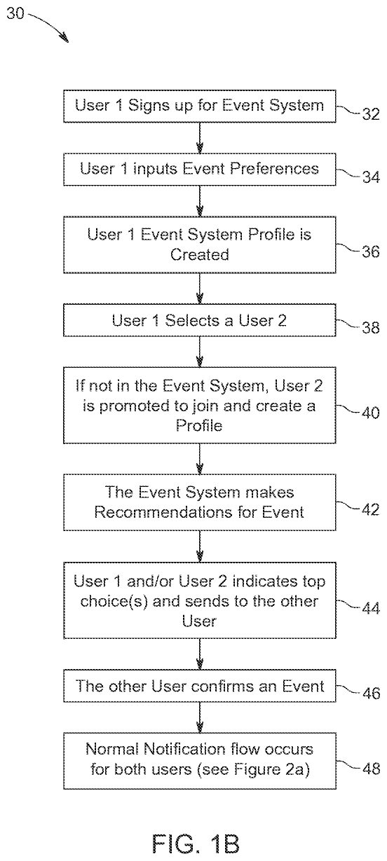

A user may use the event system to find events that they may be interested in attending. FIG. 1a illustrates a flow chart 10 of how a user uses the event system. In general, the event system provides event recommendations to a user based on the user's likes, habits, and ratings. The event system enables a user to form groups for events and to form those groups based on the rating given by the system to potential group members for certain types of events.

The user signs up with the event system 12 to receive event recommendations, purchase event tickets, calendar events, and coordinate event attendance with friends. The event system may be configured to provide event recommendations to the user based on user preferences. Signing up for the system thus generally includes inputting event preferences 14. This may be done, for example, by filling out one or more “this-or-that” questionnaires or surveys.

A this-or-that survey narrows in on preferences of a user by asking a series of questions, wherein the questions may change as the user provides answers, or wherein the questions may be static. For example, a this-or-that survey may start with a question such as “do you prefer music events or non-music events?”. The next question may be, for example, “do you prefer rock concerts or classical performances?” or “do you prefer stand-up comedy or plays?”. The system can process the this-or-that answers to develop a ranking of types of events for the user. The system can further use the this-or-that answers to develop a “percent match” of an event to a user, discussed more fully below.

In other embodiments, a user may input their event preferences 14 to the event system in any suitable manner. For example, the event system may provide a questionnaire, a this-or-that question list, or other. In one embodiment, a user is prompted to choose at least X of Y keywords associated with events they may like. For example, a user may be prompted to choose at least 5 of 20 keywords with events they may like—such as rock, opera, art festival, football, etc. In another embodiment, a user chooses types of events they like (concerts, theater, sporting events) and then may be prompted to select categories within those events (rock, alt, pop; drama, comedy; football, baseball, basketball, hockey). In another embodiment, as discussed above, the user proceeds through a this-or-that question list where the user goes through a series of choices and chooses their preference of two options in each choice. Based on the questionnaire, the question list, or any other data source regarding user preference, the event system builds an initial profile for the user that is used by a user side event recommendation algorithm. This profile may be updated automatically, such as by machine learning, as the user uses the system. Such updating may be continuous or may be periodic at set intervals or at random intervals. Alternatively, the profile may be manually updated if the user indicates they want to change aspects of their profile.

To sign up with the event system, the user may sign up directly or may sign up with a third party app such as a social media app or a dating app. When signing up with the event system, regardless of how the user signs up with the event system, the user may download an event app to their phone or mobile device. The event app of the event system may be referred to as the Nrby app. In some embodiments, when interfacing with the event system, the user may use the event app. In alternative embodiments, the user may interface with an event website or through other interface.

If signing up through a third party app, the user may be prompted to give the event system access to identifying information, such as name and email, and friend lists. The friend list may be used to populate one or more friend lists in the event system (described more fully below). If signing up directly with the event system, the user may be prompted to input identifying information, such as name and email, and to input friend information for building one or more friend lists in the event system.

Using the event system, the user has the option of building a friend list 16. The user can build a friend list in order to, for example, see events their friends are interested in, to invite friends to events, and/or to coordinate groups for an event. The friend list may be built automatically by the system by importing a friend list from a third party app. This friend list may be limited to friends on the friend list from the third party app having the event system downloaded. The friend list may be built manually be the user by inviting friends to register on the event system. Further, the friend list may be built automatically and supplemented manually. In general, the friend list may be modified by the user at any time. Further, the user may have the option of blocking certain other users from seeing the user or the user's preferences on the event app.

The event system can be used to make recommendations to the user based on their profile and, optionally, within a geographical area. The user can request recommendations based on specific details. For example, the user can input a date range and a geographical area for a recommendation. Regarding geographical area, a user may select a temporary region (for example a region to which they may be travelling) or may select their home region (based on their home address or preferred central point). Alternatively, the event system may automatically generate a geographical area. In one embodiment, to automatically determine geographical area, the system may calculate the region that is closest to the user given their latitude and longitude.

The event system queries the event database for events having a threshold level of matching with the user's profile, in the date range, and in the geographical area. A percentage may be calculated with each event indicating the likelihood that the user will be interested in the event—referred to as a percent match. Such calculation may be done based on user preferences, user past activity, or other factors.

Events in which the user may be interested are displayed to the user. The user thus receives event recommendations 18 from the system. In some embodiments, this may be limited to types of events that the user has said they are interested in. The event display can show the percent match for each event. This may be done by showing a confidence circle (discussed below). The percent match is based on the alignment of the user preferences with the event details and is indicative of the likelihood that the user will be interested in the event. The user display is discussed below with respect to the User Module.

In addition to event recommendations, the system may be configured such that a user receives notifications 20 with event recommendations for upcoming or imminent events. For example, the system may be configured to send notifications with a user's top rated events that are happening in an upcoming weekend, or on a user's preferred/available day of the week.

The user may like events (thus optimizing their event preferences) and/or may purchase tickets to events 22. If interested in an event, the user may calendar the event within the system or pushed to an outside calendar app. If the user decides to attend an event, the user can purchase tickets, either directly through the event system or through redirection to a third party ticket vendor. Any events for which tickets are purchased may be added to the user's calendar.

A user may be prompted to purchase merchandise (or other items additional to the ticket) within the event system, if listed as available by the event organizer, as described more fully below. Such prompt may be upon buying the ticket, upon creation of a group for that event (if the event cost is $0), or upon selecting attending (if the event cost is $0).

Orders can be made by users instantly through the event system. Merchandise listings may include, but are not limited to, pictures, descriptions, and cost. In one embodiment, payment processing occurs through event system and customer order information including shipping details are sent to the fulfillment center for processing. Orders may be shipped out directly to the users from the distribution facility.

After attending an event, a user is prompted to rate the event 24. That rating may be used by the user side recommendation algorithm to further refine the user's profile.

The user can also access a listing of events that their friend(s) are going to. The user can recommend events to their friend(s) and their friend(s) may recommend events to them. The user can select through the events (listed as friends attending or recommend by a friend) and purchase tickets to the event through the event system or through redirection to a third party ticket vendor.

FIG. 1b illustrates a flow chart 30 of how users can use the event system in conjunction with a third party app such as a dating app in order to facilitate pairing of users. More specifically, the event system may be integrated with third parties via API calls. In general, the event system provides event recommendations to a user based on the user's likes, habits, and ratings and these can be used to find common interests among users.

A user, for example User 1, signs up with the event system 32. The event system may be configured to provide event recommendations to the user based on user preferences. Signing up for the system thus generally includes inputting event preferences 34. This may be done, for example, by filling out one or more “this-or-that” questionnaires or surveys. In general, the user may input their event preferences to the event system in any suitable manner. Based on the questionnaire, the question list, or any other data source regarding user preference, the event system builds an initial profile for the user 36. This profile may be updated automatically, such as by machine learning, as the user uses the system. Such updating may be continuous or may be periodic at set intervals or at random intervals. Alternatively, the profile may be manually updated if the user indicates they want to change aspects of their profile.

User 1 can choose the profile of someone with whom they would like to match 38, User 2. If User 2 is on the third party app but does not have an Event System profile, User 2 is prompted to create a profile in the Event System (including by inputting event preferences) 40.

When User 1 and User 2 each have Event System profiles, the Event System can provide recommendations 42 to either user for events that they both may be interested. In some embodiments, the recommendations may be limited to parameters input by one of the users. For example, the user may specify a potential date and time for meeting and the Event System may provide recommendations only on that date at that time. Alternatively, the user may select a type of event, such as music only events, and the Event System may provide recommendations based on the type of event (and any other input parameters). The recommendations can take into account the percent match for the event with each user and provide a list of events that have the highest overlapping percent match and meet all requested parameters.

The user then chooses their top choice(s) and these are sent to the other user 44 for confirmation. For example, User 1 may ask for event recommendations, select their top choices, and send the top choices to User 2. User 2 is then prompted to confirm one of the events. User 2 may alternatively indicate they are not interested in any User 1's top choices and/or may suggest one or more other events. Different event options may be suggested back and forth until a confirmation occurs 46 (or the users decide not to meet).

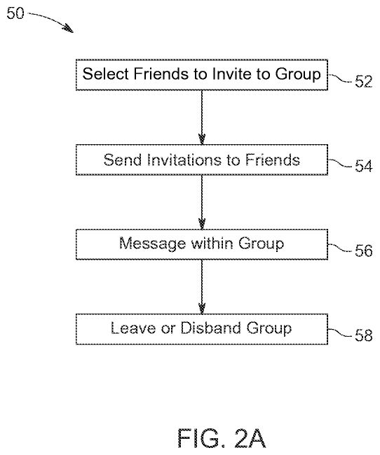

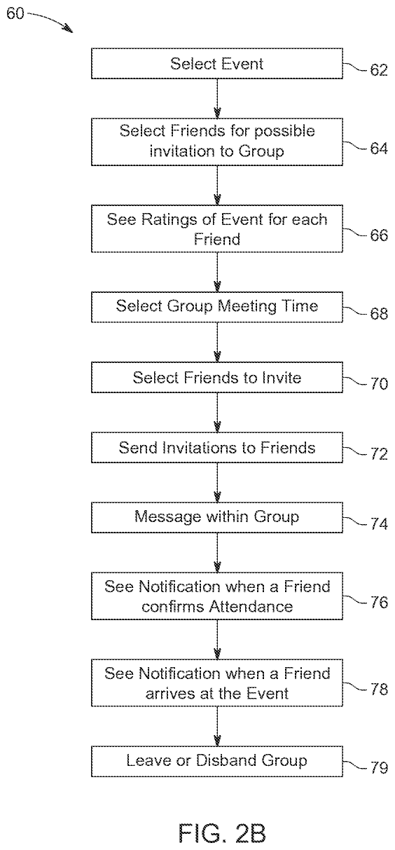

Upon confirmation, the users are prompted to indicate that they are attending the event. Mutual attending status is returned via API to the Event System and/or within the third party system. Upon confirmation of attendance, normal notification flow occurs 48 for both users as described with respect to FIG. 2.

### Group Experience

FIGS. 2a and 2b illustrate flow charts 50, 60 for group creation and use in the event system. Groups can be created for a specific event (e.g., for a specific concert) and exist only for that event. Groups can alternatively be created for a type of event and (e.g., for all outdoor country festivals in a region).

FIG. 2a illustrates a flowchart 50 of an overarching scheme for forming a group to use within the event system. A user selects friends to invite to a group 52. The user sends invitations to friends 54 to join the group. Messages can be sent within the group 56. In some embodiments, any group member may send messages; in other embodiments only the founding group member or a select set of group members may send messages. Members can leave the group and/or the group can be disbanded 58 after an event or at any other time.

When selecting friends to invite to a group, the user can see the friend's percent matches for various events. In some embodiments, a user may form a group for a specific event. This may be referred to as an event group. In some embodiments, a user may form a group and then the event system may make recommendations of events based on the percent matches of all the uses in the group. This may be referred to as a freeform group. In forming an event group, a user may select an event and then may view friends who may be interested in that event. From those friends, the user may choose which friends to invite to the event group.

In forming a freeform group, a user may select a plurality of friends and then see recommendations of events that those friends may like. This may include a Group Rating Score for each event. From those events, the user may choose an event.

The user sends invitations to friends to join the group. Once in the group, friends may send messages within the group about events or other. The event system may be configured to send push notifications to the group members. Such notifications may include, for example, that a new user has joined the group (by accepting an invitation), that a member has purchased ticket(s) to the event, that a member has arrived at the event, that a message has been sent to the group, The notification that a member has purchased tickets to the event may include how many tickets were purchased to help inform other members of whether they need to purchase a ticket or whether the member has purchased tickets for the group.

Users can leave the group and/or the group can be disbanded (for example if the friend group was created for a specific event).

FIG. 2b illustrates an embodiment of group creation and use for a specific event. As an initial step, a user selects an event 62 for which a group is being created. The user then selects friends for possible inclusion in the group 64. Upon selection, the system displays the ratings of the event for each friend. More specifically, the user can see the friend's percent match for the selected event 66—the percentage likelihood that the friend will like or dislike that specific event.

The user can view the event start time and set a group meeting time 68 (before or after the event start time).

To form a group, a user selects friends to invite 70 and sends invitations to the selected friends to join the group 72. The invitation may include the group meeting time or the group meeting time may be agreed upon after the group is formed. In some embodiments, a friend may not be able to join multiple groups for a single event. The friend can then accept or decline the invitation. In some embodiments, a friend who accepts the invitation and becomes a group member can send invitations to their friends.

Once the group is formed and friends have accepted invitations and thus joined the group, the members of the group can message one another in the event system app 74. In some embodiments, any group member may send messages; in other embodiments only the founding group member or a select set of group members may send messages.

The event system may be configured to send push notifications to the group members. In some embodiments, only the founding group member can see such notifications, in other embodiments all or some subset group members may see such notifications.

A notification may be sent when a friend confirms attendance status for an event. More specifically, a status of “attending” or “not attending” may be shown within the group. Group members can see the notification when a friend confirms attendance 76. A notification may be sent when a friend has purchased ticket(s) to the event (if the event is ticketed). The notification that a member has purchased tickets to the event may include how many tickets were purchased to help inform other members of whether they need to purchase a ticket or whether the member has purchased tickets for the group. Such purchase notification may be shown within the group. A notification may be sent when a friend arrives at the event, with the notification being shown generally within the group. Group members can see the notification when a friend confirms arrives at the event 78.

A member can choose to leave the group at any time. 79 For event specific groups, the group may be set to automatically disband at a time period after the event.

### Event Organizer Experience

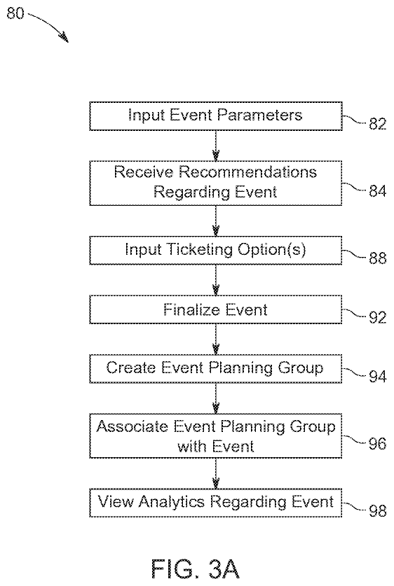

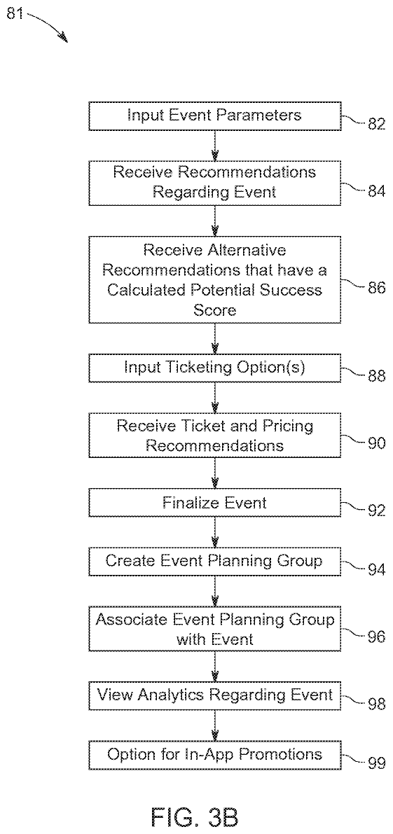

An event organizer (sometimes referred to as an event host or event planner) may use the event system to create events that can be recommended to users. It is to be appreciated that the term “event organizer” or “planner” can refer to a venue. More specifically, venue booking availability may be provided through the system such that a venue, as an event organizer, can show other event organizers availability for renting their space(s). FIGS. 3a and 3b illustrate flow charts 80, 81 of how an event organizer uses the event system. The event organizer may use a web portal to interface with the event system. Like steps of flow charts 80 and 81 have the same element number.

The event organizer creates an event. Creating an event may comprise, for example, inputting event parameters 82. Event parameters may include region, venue, type of event, keywords for event, date of event, time of event, and user requirements (e.g. over 21).

During creation of the event, the event system may provide recommendations regarding the event 84 using an event organizer side recommendation algorithm. These recommendations may include a likelihood of success percentage. The likelihood of success percentage reflects the likelihood that the event will be well attended. The event organizer can change event parameters to evaluate whether changing one or more parameters will increase the likelihood of success percentage. It is to be appreciated that what comprises a “success” level may vary based on the type of event. This may be a sliding scale based on how many other events are happening, market demographics, event types already occurring in a set time period, etc. In some embodiments, an event organizer can select a region and a date and request a recommendation for the type of event that has the highest likelihood of success percentage.

In further embodiments, and as shown in FIG. 3b, an event organizer can receive alternative recommendations 86 with other locations, dates, keywords, or event types that have a calculated potential success score. More specifically, the event system may run through various locations, dates, keywords, and event types to give recommendations that have a calculated potential success core. In such embodiments, the event organizer can input the desired potential success/likelihood of success percentage and the event system will output parameters for events that are most likely to give that potential success.

The event organizer must specify at least one ticketing option for the event 88. The ticket options can include, for example, any combination of (1) free admission, (2) tickets that are $0 to a specified capacity, (3) tickets that are greater than $0 in price. The event system may make, and the event organizer may receive, ticket and pricing recommendations 90 for events based on location, date, keywords, and/or event type.

The event organizer may restrict access to tickets to a specified date and time. This may be done, for example, to prevent unauthorized ticket resale. Logistical restriction may be done in any suitable way. For example, the tickets may be sent to a user via a QR code that directs to a URL that is not live until the specified date and time. Alternatively, an email may be sent to a user indicating that their live ticket email will be sent at the specified date and time and then a live ticket email sent at that time. In general, any way of providing a ticket link that goes live at the specified date and time may be used.

After creation of the event, including selection of all event parameters and input of at least one ticketing option, the event organizer can finalize the event 92. Upon finalization of an event, the event is visible to users on, for example, a mobile app, and any ticket options that exist are accessible.

The event organizer can create event planning groups 94, also referred to as event organizing groups. Members of the planning groups assist the event organizer in organizing and putting on an event. The event organizer can associate a planning group with an event 96. Any person can be invited to be part of the planning group and can be assigned different permissions or assignments within the planning group. In some embodiments the planning group may be exclusive to one event, in other embodiments, the planning group may be associated with multiple events. For example, an event organizer may have region specific event groups—such as a Minneapolis Planning Group—and a region specific planning group may be associated to all events that the event organizer plans in that region.

The event organizer may include a merchandise offering. For example, the event organizer may list merchandise that may be purchased at the time of ticket sale. The merchandise may be chosen to be shipped to the user or to be picked up at the venue. The user may further have the option of purchasing the merchandise through the event planning system after the ticket sale.

More specifically, event organizers are able to directly list merchandise for users to purchase in the event system with fulfillment being done through event system or contracted third-party partners. Merchandise may be shipped from a central distribution facility. Such merchandise may be sent to the central distribution by the event organizer or by a merchandise manufacturer.

In general, an event organizer may select an option where users are able to pay in advance for anything additional to event tickets, such as any items from wearable goods, to food and drink vouchers, parking permits, etc.

Order fulfillment may be done in any suitable way and generally can be based on the preference of the event organizer. The merchandise can be shipped before the event starts, after the event is finished, or user can pick up the item(s) at the event.

After creation of an event, the event organizer can use the event system to book a venue, described more fully below with respect to the event organizer module.

After an event has been published, an event organizer may view analytics regarding the event 98. These analytics may include existing event ticket purchase including number of tickets purchased, revenue earned, estimated payout, fees charged to customers, etc.

Before or after an event, an event organizer may be provided with the option for directed in-app promotions 99 to users with high ratings for the event or for similar events. In general, event organizers may have access to ratings for events for existing users based on the user's profile and event preferences. The event organizer thus can target in-app promotions to users who have, for example, a desired percent match (for example over 50%) for an event.

### System

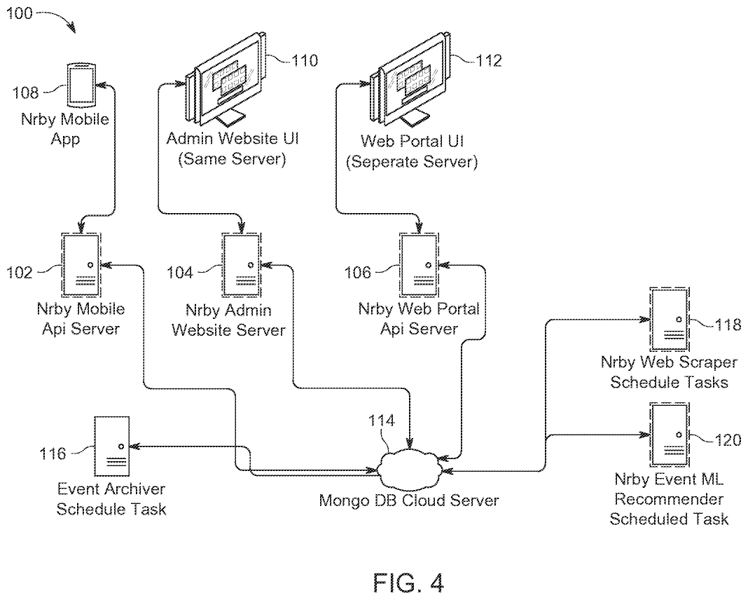

FIG. 4 illustrates a block diagram of an exemplary event system 100, in accordance with one embodiment. As shown, the system may include three servers: A Mobile API Server 102 (user server), an Admin Website Server 104 (administrator server), and a Web Portal API Server 106 (event organizer server). Each of these servers may be associated with a user interface. For example, the Mobile API Server 102 may be associated with a mobile app 108 which a user may use to access the event system 100. The Admin Website Server 104 may be associated with an Admin Website 110 user interface which an admin may use to access the event system 100. The Web Portal API Server 106 may be associated with a Web Portal user interface 112 which an event organizer can use to access the event system 100.

Each of the Mobile API Server 102, the Admin Website Server 104, and the Web Portal API Server 106 may be linked to a Cloud Server 114 for storing data. In the embodiment shown, the Cloud Server 114 works with task algorithms. These task algorithms may include an event archiver schedule task algorithm 116, a web scraper schedule task algorithm 118, and an event recommender task algorithm 120. The algorithms may be schedule to run on a schedule such as once daily and send data back to the cloud server, which can be pushed to the respective server.

In some embodiments, a Third Party API may be provided. A Third Party Mobile App user interface and/or a Third Party Website user interface may be provided associated with the Third Party API. The Third Party API may be linked to the Cloud Server 114

### User Module

The User Module is the module used by a user interested in going to events. The User Module may include, for example, a mobile app. A user interface is associated with the User Module for facilitating user use of the User Module.

### User Display

In one embodiment, the user's primary interface is a map of the area around them. The user receives recommended events (or can set the event system to show all events) as pins on a map. There are a series of cards that can be scrolled through to cycle between the visible pins. These cards may be expanded to provide more details about the event.

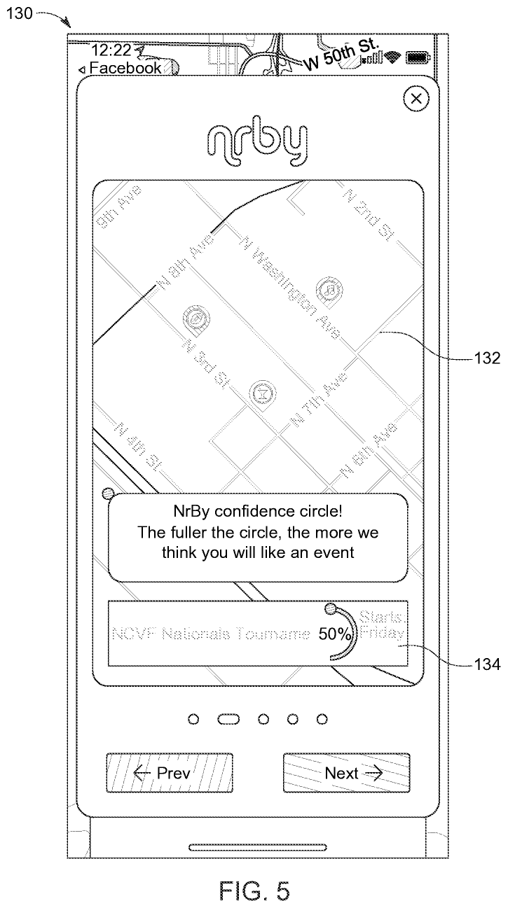

Events on the map may display a confidence circle, as shown in FIG. 5. FIG. 1 illustrates a screenshot showing a map 132 and a confidence circle 134. As shown, the confidence circle reflects the percent match of the user to the event. In FIG. 5, the percent match is 50% and the circle is filled in to a half circle. This half circle may be green, indicating a likely match. In a percent match of 25%, the circle is filled in to a quarter circle and may be red, indicating not a likely match. In other embodiments, a thumbs up (optionally green), for example for a 50% or more percent match, and a thumbs down (optionally red), for example for a less than 50% percent match, may be shown.

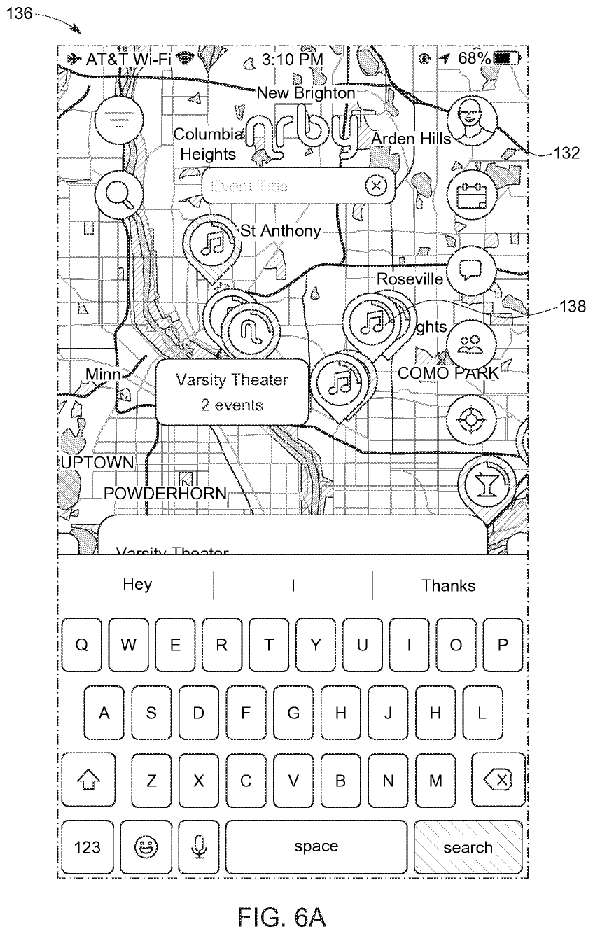

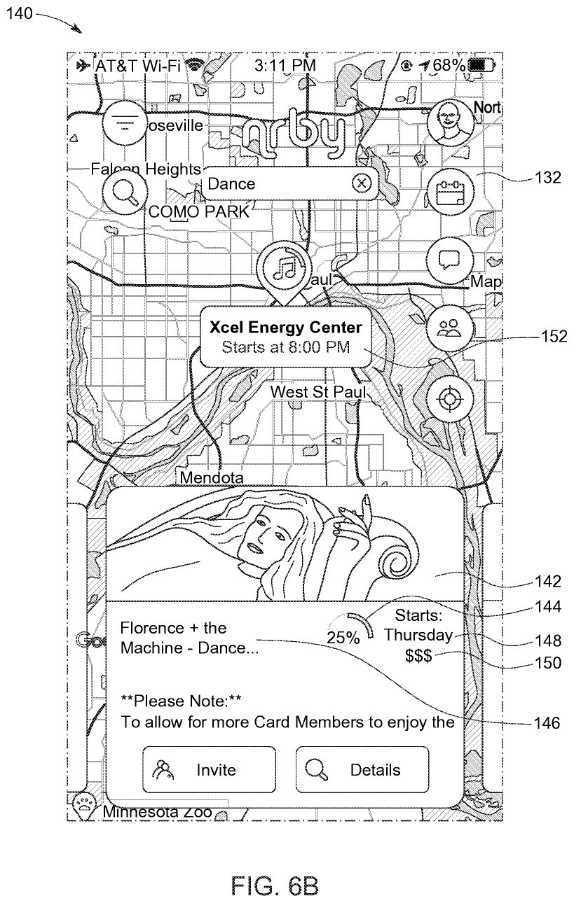

FIG. 6a illustrates a search screen 136 overlaying a map 132 of an area. As shown, various events are shown as pins 138. A user can search by venue, event title, event type, keyword, or other. FIG. 6b illustrates a result screen 140 of a search for the keyword “Dance” and including an event card 142 for a result. In the embodiment shown, the event card includes the percent match 144 (25% in the example), the event title 146, the event date 148, and a cost indicator 150. The venue and time 152 are shown on the map 132.

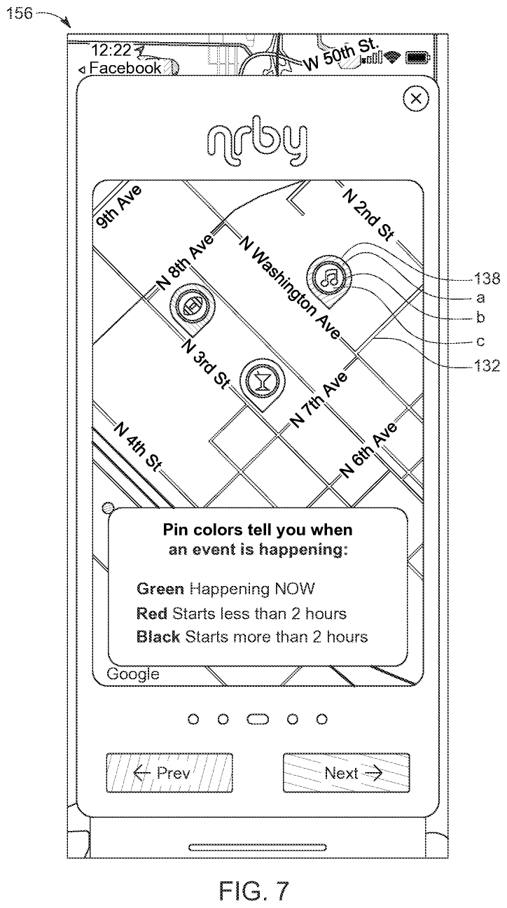

FIG. 7 illustrates a map screen 156 showing pins 138 that may be provided on a map 132, in accordance with one embodiment. As shown, the pins may include an outer color a, and inner color b, and an event indicator c. The outer color a may correspond to timing of the event. For example, an outer green pin may indicate the event is happening now, an outer red pin may indicate that the event is happening in less than two hours, and an outer black pin may indicate that an event is happening in more than two hours. This example gives color codings for relatively immediate events (such as if a user is looking for an event to attend that day). The user may alternatively select color coding for future events where an outer green pin indicates that an event is happening in the next week, an outer red pin may indicate that an event is happening in the next month, and an outer black pin indicates that an event is happening in more than a month. The inner color b of the pin is a visual indicator of the percent match of the event to the user.

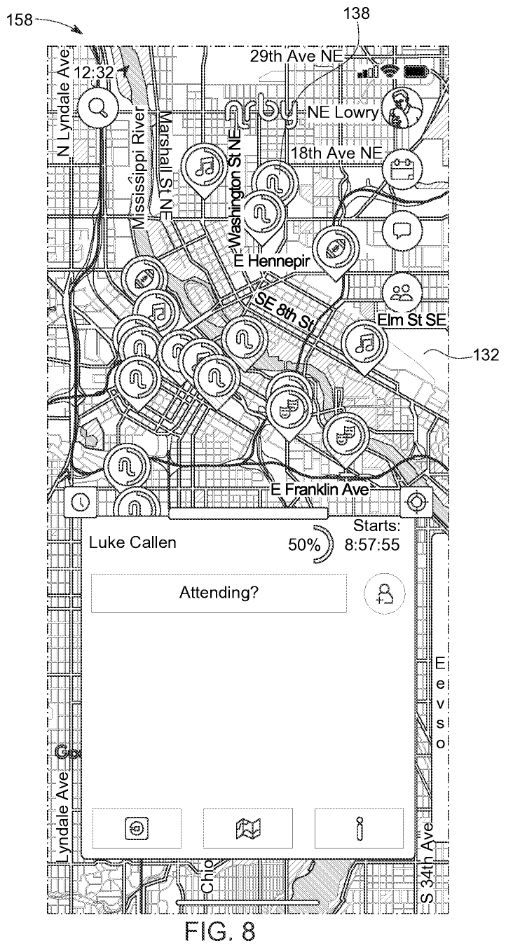

FIG. 8 illustrates screen 158 showing a map 132 with pins 138, in accordance with one embodiment. As discussed above with respect to FIG. 7, the outer color corresponds to timing of the event and may be selected to reflect immediate timing or future timing. The inner color of the pin is a visual indicator of the percent match of the event to the user. Green may indicate a percent match of 50% or more and red may indicate a percent match of less than 50%. The inner ring may further correspond to a confidence circle, described with respect to FIG. 5, and the color may be illustrates along a percentage of the circle. The event indicator may be provided generally central to the pin and may reflect the type of event—such as theater, sports, concert, etc.

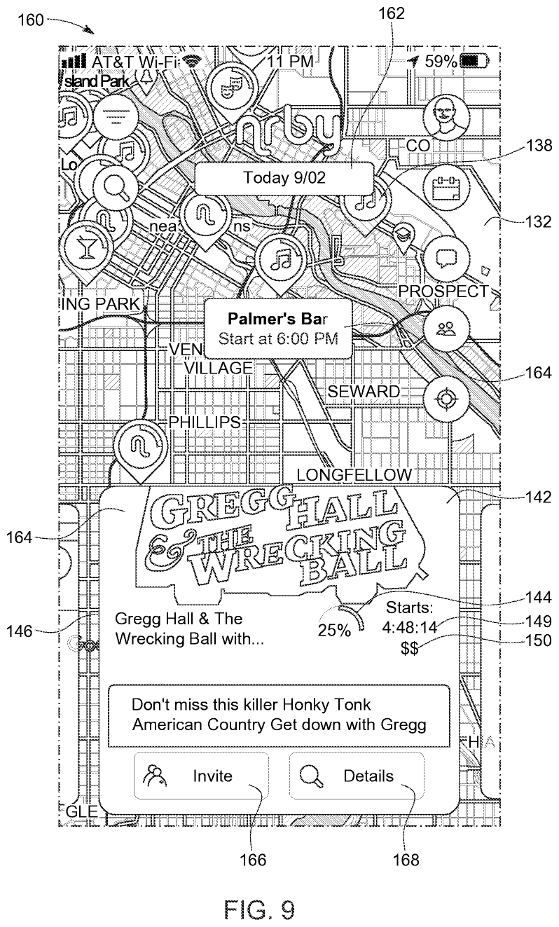

FIG. 9 illustrates a screen 160 including a map 132, a date for events 162, pins 138 with events occurring on that date, and an event card 142 for a selected event on that date, in accordance with one embodiment. As shown, the event card 142 may include the event name 146, an image associated with the event 164, the start time 149 of the event, the percent match 144 for the event, and a price indicator 150 for the event. The venue 164 for the event may be shown on the map 132. In some embodiments, the event card may give the user an option to see further details 168 and/or to invite others 166 to the event.

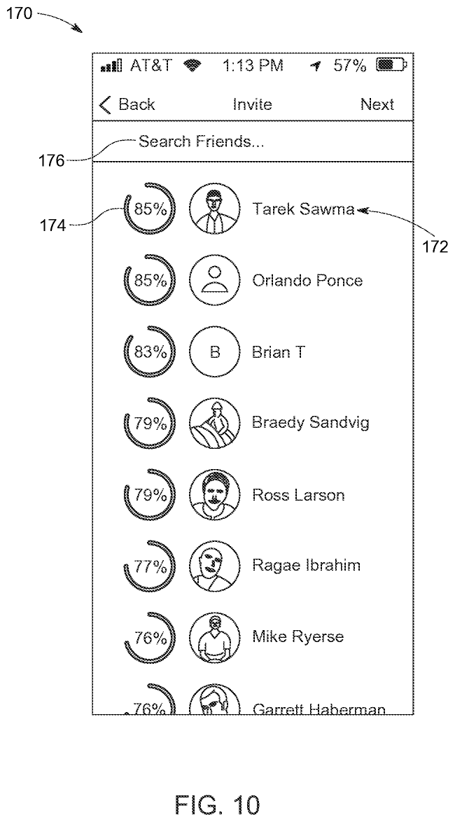

FIG. 10 illustrates a friend invitation screen 170. As shown, the user is presented with a list of friends 172 and their percent matches 174 with the event being viewed. A user can select friends from the list and/or can search 176 for a specific friend(s) to invite.

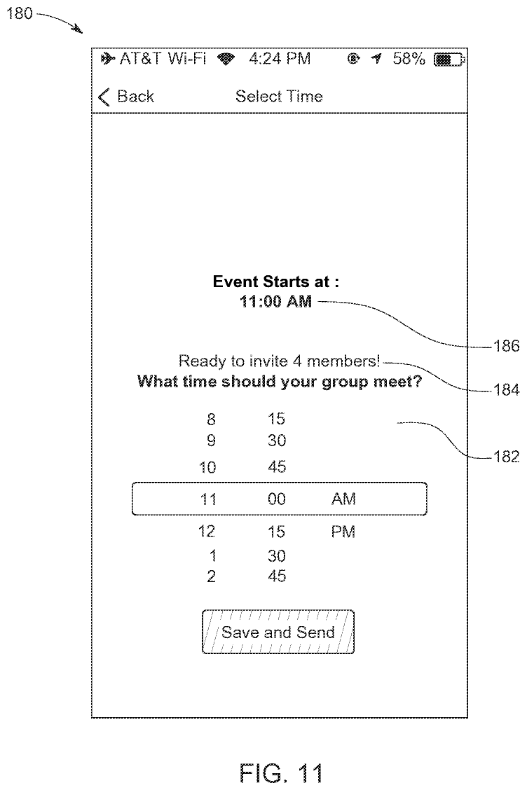

FIG. 11 illustrates a meet time invitation screen 180. Upon selection of what friends to invite to the event (described with respect to FIG. 2a), a user may be prompted to select a time 182 for the group to meet. The meet time invitation screen may include details about the event and/or about the group. In the example shown, the meet time invitation screen indicates how many people are in the group 184 and what time the event starts at 186.

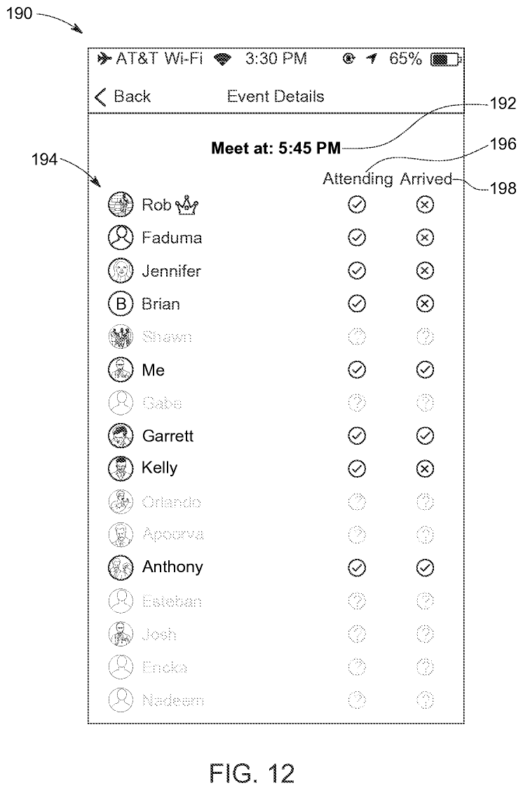

FIG. 12 illustrates a group event details screen 190. As shown, the group event details screen 190 shows a meeting time 192 and a list of friends 194. The list of friends includes an indication of whether each friend is attending 196 and whether each friend has arrived 198.

Returning to the event card, in some embodiments the user may be presented with ticket buy options in the expanded version of each event card. The user can choose how many of each ticket they want to purchase. Once they have made their selection, the user can go to a preview order screen. The preview order screen previews total costs including ticket prices, service fees, sales tax, processing fees (for example, Stripe processing fee) and the total cost. The user can choose to checkout, which results in the finalized order.

If the order is greater than $0 (it may be $0 for free events), the user will be prompted to enter payment information and will be charged via a payment processing system (such as the Stripe Payment System). Once the payment is successfully process, the payment processing system sends a payment status update to the event system and the event is set to a successful state. Access information is created for the user to access the tickets. For example, a QR code may be generated.

If the order is $0, the event is automatically set to a successful state and access information is created for the user to access the tickets. For example, a QR code may be generated. Access to the QR code, or to the tickets through the QR code, may be date and time restricted (described more fully above). If date and time restricted, the user may be given information about accessing their tickets at that time.

Once tickets are purchased, the user can view their ticket access information through a tickets button visible on the expanded event card.

Users can send tickets directly to other members, for example, members of a group, by pressing a “Share Ticket” button under ticketing. In one embodiment, a share ticket menu opens and the user can either send the ticket to a member or can text the ticket out.

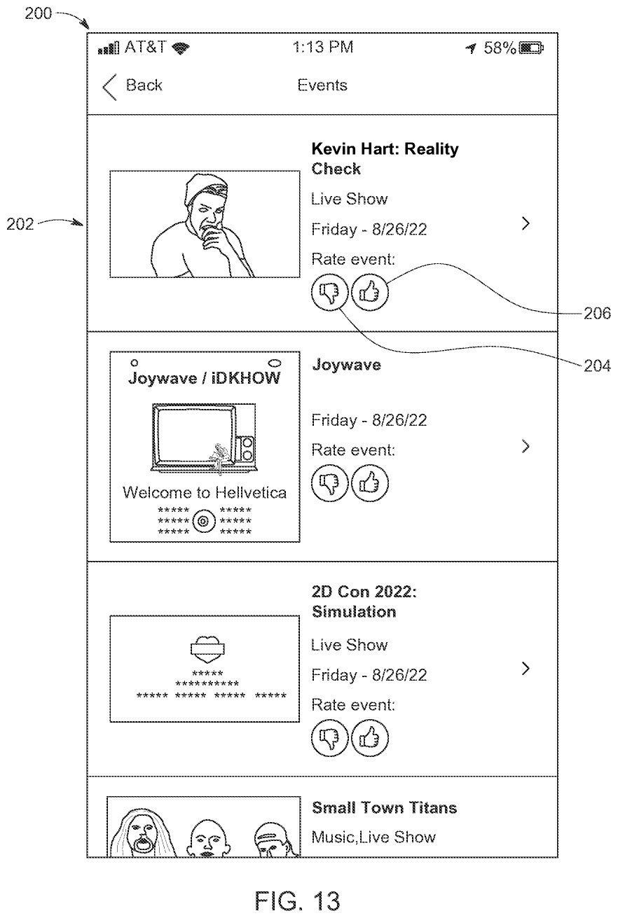

FIG. 13 illustrates an upcoming events screen 200. A list of upcoming events 202 can be automatically generated. For example, a list of events on a weekend may be generated the preceding Wednesday. A user can be prompted to rate the event with a thumbs up 204 or a thumbs down 206 to further optimize the user's event preferences.

### Recommendation Engine—User Side

The Event System includes a user side recommendation engine. The user side recommendation engine runs an algorithm to process event data and user profile data (such as preferences and history) to generate a percent match/make recommendations of events to users. This algorithm is associated with the Event Recommender Scheduled Task.

In one embodiment, the recommendation engine is a single console application that runs, for example, once daily. The recommendation may be configured to use free Machine Learning developed by Microsoft, or other machine learning or machine learning algorithms. The machine learning model is trained using a user's past event associations (attendance or marked interest). Keywords associated with these events and the users rating of the event are metrics that may be fed into the machine learning model for training it to make recommendations.

Once the model is trained, the algorithm is applied to all upcoming events to generate a percent match for the user for all events. The percent match is based on the alignment of the user preferences with the event details and is indicative of the likelihood that the user will be interested in the event. Upon generation of the percent match, the percent match is saved to the database and viewable by a user. Thus, when a user views an event, they can see their percent match for it. In some embodiments, events that have a percent match above a certain threshold may be highlighted to the user.

### Organizer Module

The Organizer Module is the module used by an event creator. The Organizer Module may include, for example, a web portal and a web portal user interface.

### Organizer User Display

The organizer module may comprise a web portal that the event organizer interfaces with in order to create and save an event.

Administrators of the web portal may change any data and have their own series of dashboard to manage web portal data that is not accessible to users and event organizers.

### Venue Booking Sub-Module

The event system includes a venue booking sub-module to help connect venues with available space and event organizers who need to rent space to hold an event. When a venue uses the web portal (associated with the event organizer module) to list and sell tickets, they give the event system access to their full event calendar. The event system can be prompted to bulk select all other days without a scheduled event and list them for rent in the web portal. The venue is able to set the price they are willing to book the space for and this information is displayed in the web portal for event organizers to view. The event organizer can then request to book the venue. When an event organizer makes such request in the event system, the event system alerts the venue and requests a confirmation. After confirmation, payment may be done between the event organizer and the venue or through event system.

### Recommendation Engine—Organizer Side

The Event System includes a organizer side recommendation engine. The organizer side recommendation engine runs an algorithm to process event data against proposed events being planned by the event organizer to generate a percent likelihood of success. The likelihood of success percentage reflects the likelihood that the event will be well attended. This algorithm is associated with the Event Recommender Scheduled Task.

In one embodiment, the recommendation engine is a single console application that runs, for example, once daily. The recommendation may be configured to use free Machine Learning developed by Microsoft, or other machine learning or machine learning algorithms. The machine learning model is trained using a consolidated list of crawled events and the events listed directly on the event system (by event organizers). It also may use time/date associated with each event, keywords associated with each event, the number of events in a region for a category (the more of the same event category, the less likely any one event will be successful due to limits on available people/audience within the region), event revenue of this type of event against other parameters. The algorithm analyzes event system user data to determine projected attendance for a given date to other events. The algorithm further analyzes existing proprietary event data for number of attendees per event based on day of week or time of day. These metrics may be fed into the machine learning model for training it to output a percent likelihood of success and/or make recommendations

Once the model is trained, the algorithm is applied to all upcoming events to generate a likelihood of success and/or recommendation for an event organizer based on what days of the week and time of day would be more advantageous for specific keywords and event categories. In some embodiments, the category and event keywords drive the algorithm analysis. Once the recommendations are generated, they are saved to the event database and can be used at any time. Once saved to the event database, the event organizer scheduling an event is able to see what their percent likelihood of success for the specific parameters is and/or a time/date recommendation for an event having a specific category and venue.

In some embodiments, a web scraper may be used to collect the number of sold tickets to an event, the number of available tickets to an event, the total amount of venue max capacity space (both used and unused for a specific date and time), and trending social media tags for a specific venue and/or a specific event. The event system can use the total ticket sales purchased through the event system and compare that against the total active user base in a region. Based on this, the event system is able to guide predictive success scores for event organizers and venues by calculating the potential available event goer userbase. The event system can cross reference applicable data points to help guide an accurate predictive success score.

### Administrator Module

The Administrator Module is the module used by an administrator of the event planning system. The Administrator Module may include, for example, an admin website, a web scraper, an event database, and an admin website user interface.

### Spider

The Administrator Module includes a web scraper, referred to as a spider, for finding events. The spider can be set to look at individual regions and find events in that region to populate to an event database. For each region, the spider is configured as a different Spider Location. The spider may have configuration settings that target specific event details from external data sources. External data sources may include, for example Eventbrite™, Meetup™, etc.

To create a new Spider Location, configurations from an existing Spider Location may be copied to a new Spider Location that shares the same event field targeting information. Spider Locations with the same event field targeting information may be grouped together so bulk edit operations can be performed on a plurality of spider locations upon updating a of a single Spider Location in a group.

Migrations can be performed between test and production environments so that a configuration that is changed or added in a test database can be migrated to a production database (or vice versa). Spider Locations can be tested via the admin website using a lightweight version of the web scraper code to verify that a data source passes validation.

Each different region for each web scraper location (Spider Location) may have its own console application. In general, regions are defined as central event hubs. For example, a region may be a metropolitan area. In one embodiment, each region gets a new instance of the web scraper application activated by a daily scheduled task. Once the web scraper is run, the event system gets all Spider Locations configurations for the run region and consumes events from the associated data sources.

In some situations, events may be culled directly from a third party API rather than through scraping. For example, for major third party ticket vendors, such as Ticketmaster™ and StubHub™,

Events are uploaded to an Event Database. In some embodiments, before an event is uploaded to the Event Database, it has to pass a series of validations. Parallel programming may be used to process multiple events at once to increase the web scraper's efficiency. Once events are uploaded to the Event Database, they are viewable by users.

In some situations, events may be removed from the Event Database and archived, for example on a separate storage medium. For example, if an event occurring in the future was added to the Event Database based on a first web scraping and then is not present in a second web scraping, the event may be removed from the Event Database. Further, events that have passed that have no user connection (meaning that no users expressed interest in the event or purchased tickets to the event), the event may be archived to a separate storage meeting. Events that occur in the past are also archived.

### Validation

The event system may have validation algorithms, such as an event validation algorithm and an event organizer validation algorithm.

An event validation algorithm validates an event before it is added to the event database. This may include such as validating the event name, date/time, address, venue, etc. Such event validation may be applied to events that are web scraped by a Location Spider and to events that are generated by an event organizer on the event system.

An event organizer validation algorithm validates an event organizer before the event organizer is elevated to event organizer within the event system. Event organizer validation may be done to confirm that the event organizer is a legitimate event organizer and, upon such validation, events hosted by the event organizer may be shown to the user as validated events. Event validation may be done by an event organizer validation algorithm. Validation may be done through various means including, but not limited to, business EIN verification, direct referrals, confirmed event hosting history, etc.

### Total Ticket Centralization System

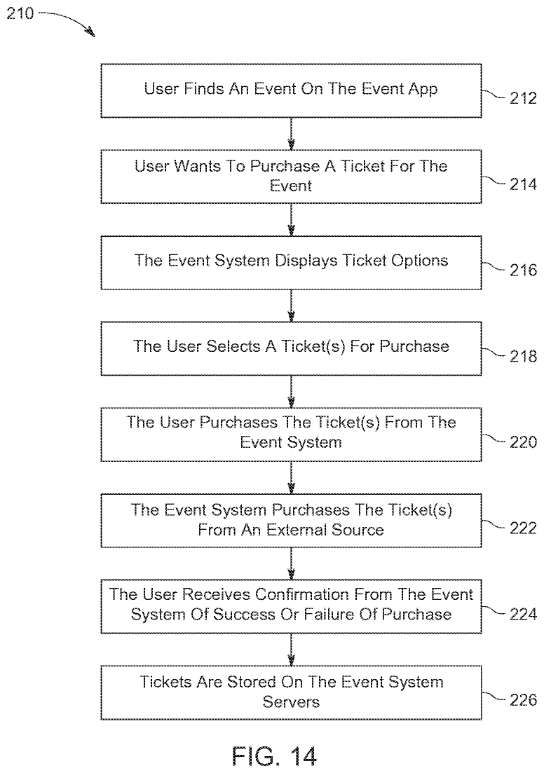

FIG. 14 illustrates a flow chart of the event system being used as a total ticket centralization system. As shown, a user finds an event on the Event App 212 and wants to purchase a ticket for the event 214. Tickets being sold through an external system may be consolidated by the event system for offering to the user.

In such situation, the event system may have preset needed user requirements for ticket purchase from each external ticket source (backend). The event system displays ticket options 216 to the user, which may be based in part on the preset needed user requirements. The user selects a ticket(s) for purchase 218, for example in real time. The user purchases the ticket(s) from the event system 220 (frontend). This may be done by entering payment information and personal information for purchase within the event system. Based on the purchase by the user, the event system purchases ticket(s) for the user in real-time from the external source 222 (backend).

The user receives confirmation from the event system of success or failure of the purchase 224. If successful, the tickets may be stored on the event system server(s) 226 and displayed in-app. This may include scannable data such as a QR code or a bar code. The tickets may be stored as a native component.

For purposes of this disclosure, any system described herein may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, a system or any portion thereof may be a minicomputer, mainframe computer, personal computer (e.g., desktop or laptop), tablet computer, embedded computer, mobile device (e.g., personal digital assistant (PDA) or smart phone) or other hand-held computing device, server (e.g., blade server or rack server), a network storage device, or any other suitable device or combination of devices and may vary in size, shape, performance, functionality, and price. A system may include volatile memory (e.g., random access memory (RAM)), one or more processing resources such as a central processing unit (CPU) or hardware or software control logic, ROM, and/or other types of nonvolatile memory (e.g., EPROM, EEPROM, etc.). A basic input/output system (BIOS) can be stored in the non-volatile memory (e.g., ROM), and may include basic routines facilitating communication of data and signals between components within the system. The volatile memory may additionally include a high-speed RAM, such as static RAM for caching data.

Additional components of a system may include one or more disk drives or one or more mass storage devices, one or more network ports for communicating with external devices as well as various input and output (I/O) devices, such as digital and analog general purpose I/O, a keyboard, a mouse, touchscreen and/or a video display. Mass storage devices may include, but are not limited to, a hard disk drive, floppy disk drive, CD-ROM drive, smart drive, flash drive, or other types of non-volatile data storage, a plurality of storage devices, a storage subsystem, or any combination of storage devices. A storage interface may be provided for interfacing with mass storage devices, for example, a storage subsystem. The storage interface may include any suitable interface technology, such as EIDE, ATA, SATA, and IEEE 1394. A system may include what is referred to as a user interface for interacting with the system, which may generally include a display, mouse or other cursor control device, keyboard, button, touchpad, touch screen, stylus, remote control (such as an infrared remote control), microphone, camera, video recorder, gesture systems (e.g., eye movement, head movement, etc.), speaker, LED, light, joystick, game pad, switch, buzzer, bell, and/or other user input/output device for communicating with one or more users or for entering information into the system. These and other devices for interacting with the system may be connected to the system through I/O device interface(s) via a system bus, but can be connected by other interfaces such as a parallel port, IEEE 1394 serial port, a game port, a USB port, an IR interface, etc. Output devices may include any type of device for presenting information to a user, including but not limited to, a computer monitor, flat-screen display, or other visual display, a printer, and/or speakers or any other device for providing information in audio form, such as a telephone, a plurality of output devices, or any combination of output devices.

A system may also include one or more buses operable to transmit communications between the various hardware components. A system bus may be any of several types of bus structure that can further interconnect, for example, to a memory bus (with or without a memory controller) and/or a peripheral bus (e.g., PCI, PCIe, AGP, LPC, I2C, SPI, USB, etc.) using any of a variety of commercially available bus architectures.

One or more programs or applications, such as a web browser and/or other executable applications, may be stored in one or more of the system data storage devices. Generally, programs may include routines, methods, data structures, other software components, etc., that perform particular tasks or implement particular abstract data types. Programs or applications may be loaded in part or in whole into a main memory or processor during execution by the processor. One or more processors may execute applications or programs to run systems or methods of the present disclosure, or portions thereof, stored as executable programs or program code in the memory, or received from the Internet or other network. Any commercial or freeware web browser or other application capable of retrieving content from a network and displaying pages or screens may be used. In some embodiments, a customized application may be used to access, display, and update information. A user may interact with the system, programs, and data stored thereon or accessible thereto using any one or more of the input and output devices described above.

A system of the present disclosure can operate in a networked environment using logical connections via a wired and/or wireless communications subsystem to one or more networks and/or other computers. Other computers can include, but are not limited to, workstations, servers, routers, personal computers, microprocessor-based entertainment appliances, peer devices, or other common network nodes, and may generally include many or all of the elements described above. Logical connections may include wired and/or wireless connectivity to a local area network (LAN), a wide area network (WAN), hotspot, a global communications network, such as the Internet, and so on. The system may be operable to communicate with wired and/or wireless devices or other processing entities using, for example, radio technologies, such as the IEEE 802.xx family of standards, and includes at least Wi-Fi (wireless fidelity), WiMax, and Bluetooth wireless technologies. Communications can be made via a predefined structure as with a conventional network or via an ad hoc communication between at least two devices.

Hardware and software components of the present disclosure, as discussed herein, may be integral portions of a single computer, server, controller, or message sign, or may be connected parts of a computer network. The hardware and software components may be located within a single location or, in other embodiments, portions of the hardware and software components may be divided among a plurality of locations and connected directly or through a global computer information network, such as the Internet. Accordingly, aspects of the various embodiments of the present disclosure can be practiced in distributed computing environments where certain tasks are performed by remote processing devices that are linked through a communications network. In such a distributed computing environment, program modules may be located in local and/or remote storage and/or memory systems.

As will be appreciated by one of skill in the art, the various embodiments of the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, middleware, microcode, hardware description languages, etc.), or an embodiment combining software and hardware aspects. Furthermore, embodiments of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. Computer-executable program code for carrying out operations of embodiments of the present disclosure may be written in an object oriented, scripted or unscripted programming language such as Java, Perl, PHP, Visual Basic, Smalltalk, C++, or the like. However, the computer program code for carrying out operations of embodiments of the present disclosure may also be written in conventional procedural programming languages, such as the C programming language or similar programming languages. A code segment may represent a procedure, a function, a subprogram, a program, a routine, a subroutine, a module, an object, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the context of this document, a computer readable medium may be any medium that can contain, store, communicate, or transport the program for use by or in connection with the systems disclosed herein. The computer-executable program code may be transmitted using any appropriate medium, including but not limited to the Internet, optical fiber cable, radio frequency (RF) signals or other wireless signals, or other mediums. The computer readable medium may be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device. Computer-readable media includes, but is not to be confused with, computer-readable storage medium, which is intended to cover all physical, non-transitory, or similar embodiments of computer-readable media.

Various embodiments of the present disclosure may be described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks. Alternatively, computer program implemented steps or acts may be combined with operator or human implemented steps or acts in order to carry out an embodiment of the invention.

Additionally, although a flowchart or block diagram may illustrate a method as comprising sequential steps or a process as having a particular order of operations, many of the steps or operations in the flowchart(s) or block diagram(s) illustrated herein can be performed in parallel or concurrently, and the flowchart(s) or block diagram(s) should be read in the context of the various embodiments of the present disclosure. In addition, the order of the method steps or process operations illustrated in a flowchart or block diagram may be rearranged for some embodiments. Similarly, a method or process illustrated in a flow chart or block diagram could have additional steps or operations not included therein or fewer steps or operations than those shown. Moreover, a method step may correspond to a method, a function, a procedure, a subroutine, a subprogram, etc.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, the nearness of completion will be so as to have generally the same overall result as if absolute and total completion were obtained. The use of “substantially” is equally applicable when used in a negative connotation to refer to the complete or near complete lack of an action, characteristic, property, state, structure, item, or result. For example, an element, combination, embodiment, or composition that is “substantially free of” an element may still actually contain such element as long as there is generally no significant effect thereof.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

Additionally, as used herein, the phrase “at least one of [X] and [Y],” where X and Y are different components that may be included in an embodiment of the present disclosure, means that the embodiment could include component X without component Y, the embodiment could include the component Y without component X, or the embodiment could include both components X and Y. Similarly, when used with respect to three or more components, such as “at least one of [X], [Y], and [Z],” the phrase means that the embodiment could include any one of the three or more components, any combination or sub-combination of any of the components, or all of the components.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

1. A system for event organizing and attending, the system comprising:
a user API server and a user interface associated with the user API server;
an admin server;
an event organizer API server and an event organizer interface associated with the event organizer API server;
a cloud server linked to each of the user API server, the admin server, and the event organizer API; and
at least one task algorithm associated with the cloud server, wherein the at least one task algorithm includes an event recommender task algorithm, wherein the event recommender task algorithm uses data from a user and data about an event to make an event recommendation to a user based on a percent match.

2. The system of claim 1, wherein the event recommender task algorithm uses event data from an event organizer and regional data to make event hosting recommendations based on a likelihood of success.

3. The system of claim 1, wherein the at least one task algorithm further comprises an event archiver schedule task algorithm and a web scraper schedule task algorithm.

4. A method for making recommendations to a user, wherein the user is an event
goer:
receiving user preferences regarding events;
developing a user profile based on the received user preferences;
comparing the user preferences against event data for an event;
calculating a percent match between the user profile and the event;
presenting the percent match to the user.

5. The method of claim 4, further comprising refining the user profile based on events attended by the user.

6. The method of claim 4, further comprising calculating percent matches between friend user profiles and the event and presenting the percent matches to the user.

7. The method of claim 6, wherein the user invites friends to the event based on the percent match of the friend user profile and the event.

8. The method of claim 7, wherein friends who accept an invitation from the user are grouped into an event group.

9. The method of claim 8, wherein the user sets a meet time for the event group.

10. The method of claim 9, further comprising sending a notification to members of the event group.

11. The method of claim 10, wherein the notification is sent when a member purchases a ticket to the event.

12. The method of claim 10, wherein the notification is sent when a member arrives at the event.

13. The method of claim 4, further comprising identifying upcoming events, comparing the user preferences against event data for the upcoming events, and sending notifications to the user with recommendations for certain upcoming events.

14. The method of claim 10, wherein the certain upcoming events are selected based on calculating a percent match between the user profile and each event and choosing the certain events based on events that exceed a threshold percent match.

15. A method for making recommendations to a user, wherein the user is an event
organizer:
receiving proposed event details for a proposed event;
comparing the proposed event details against existing event details of scheduled events;
calculating a percent likelihood of success of the proposed event; and
presenting the percent likelihood of success to the event organizer.

16. The method of claim 15, wherein the proposed event details comprise the type of event.

17. The method of claim 16, wherein the proposed event details further comprise at least one of a date, time, and region.

18. The method of claim 15, further comprising evaluating alternative event details for the proposed event, calculating a percent likelihood of success based on the alternative event details, and presenting at least one alternative recommendation for the event.

19. The method of claim 18, wherein the at least one alternative recommendation is made based on exceeding a threshold percent likelihood of success.

20. The method of claim 15, further comprising providing analytics regarding the event after the event takes place.
